(19) United States
(12) Patent Application Publication
(10) Pub. No.: US 2026/0059311 A1
(43) Pub. Date: Feb. 26, 2026

(54) METHODS AND APPARATUSES FOR PROVIDING USER CONSENT INFORMATION FOR DATA COLLECTION SERVICES IN A WIRELESS COMMUNICATIONS NETWORK

(71) Applicant: Lenovo (Singapore) Pte. Limited, Singapore (SG)

(72) Inventors: Andreas Kunz, Ladenburg (DE); Konstantinos Samdanis, Munich (DE); Sheeba Backia Mary Baskaran, Friedrichsdorf (DE)

(73) Assignee: Lenovo (Singapore) Pte. Limited, Singapore (SG)

(21) Appl. No.: 19/103,639

(22) PCT Filed: Sep. 23, 2022
(86) PCT No.: PCT/EP2022/076562

§ 371 Date: Feb. 13, 2025

(30) Foreign Application Priority Data
Aug. 18, 2022 (GR) 20220100696

(51) Int. Cl. H04W 12/069; H04W 12/041; H04W 12/0433

(52) U.S. Cl. CPC H04W 12/069; H04W 12/041; H04W 12/0433

(57) ABSTRACT

There is provided an apparatus (506) comprising: a transceiver; and a processor coupled to the transceiver, the processor and the transceiver configured to cause the apparatus to: receive (514) an Authentication and Key Management for Applications, AKMA, application key request from an Application Function (508), the AKMA application key request comprising: an identifier of the Application Function (AF_ID); acquire (518) user consent information; evaluate (518) the user consent information for a service provided by the Application Function (508) identified by the Application Function Identifier; detect (518) that no user consent is granted to the service provided by the Application Function (508) identified by the Application Function Identifier; and, responsive to detecting that no user consent is granted to the service, send (520), in response to the AKMA application key request, to the Application Function (508), a first AKMA application key response message indicating that no user consent is granted to the service.

### FIELD

The subject matter disclosed herein relates generally to the provision of user consent information for data collection services in a wireless communications network. This document defines methods and apparatuses for providing user consent information for data collection services in a wireless communications network.

### BACKGROUND

In the current study of TR 23.700-80, user consent is required for providing Artificial Intelligence (AI)/Machine Learning (ML) analytics to a user equipment (UE).

There are several solutions in TR 23.700-80 that query the user consent for AI/ML analytics, but all of them tend to be linked to the Network Data Analytics Function (NWDAF) requesting user consent from the United Data Management (UDM) entity.

### SUMMARY

Disclosed herein are procedures for providing user consent information for data collection services. Said procedures may be implemented by various apparatuses in a wireless communication network.

There is provided an apparatus comprising: a transceiver; and a processor coupled to the transceiver, the processor and the transceiver configured to cause the apparatus to: receive an Authentication and Key Management for Applications, AKMA, application key request from an Application Function, the AKMA application key request comprising: an identifier of the Application Function; acquire user consent information; evaluate the user consent information for a service provided by the Application Function identified by the Application Function Identifier; detect that no user consent is granted to the service provided by the Application Function identified by the Application Function Identifier; and, responsive to detecting that no user consent is granted to the service, send, in response to the AKMA application key request, to the Application Function, a first AKMA application key response message indicating that no user consent is granted to the service.

There is provided a method performed by an apparatus in a mobile network, the method comprising: receiving an Authentication and Key Management for Applications, AKMA, application key request from an Application Function, the AKMA application key request comprising: an identifier of the Application Function; acquiring user consent information; evaluating the user consent information for a service provided by the Application Function identified by the Application Function Identifier; and either: detecting that no user consent is granted to the service provided by the Application Function identified by the Application Function Identifier; and, responsive to detecting that no user consent is granted to the service, sending, in response to the AKMA application key request, to the Application Function, a first AKMA application key response message indicating that no user consent is granted to the service; or detecting that user consent is granted to the service provided by the Application Function identified by the Application Function Identifier; and responsive to detecting that user consent is granted to the service, sending, in response to the AKMA application key request, to the Application Function, a second AKMA application key response message comprising a first security key.

There is provided an apparatus comprising: a transceiver; and a processor coupled to the transceiver, the processor and the transceiver configured to cause the apparatus to: receive, from a user equipment, UE, apparatus, a first request, the first request being a request to establish an application session; responsive to receiving the first request, send a second request for use by a network entity, the second request comprising: an identifier of an Application Function, the Application Function being associated with the first request; responsive to sending the second request, receive user consent information; evaluate the user consent information for a service provided by the Application Function identified by the Application Function Identifier; detect that no user consent is granted to the service provided by the Application Function identified by the Application Function Identifier; and, responsive to detecting that no user consent is granted to the service, rejecting the establishment of the application session.

There is provided a method performed by an apparatus in a mobile network, the method comprising: receiving, from a user equipment, UE, apparatus, a first request, the first request being a request to establish an application session; responsive to receiving the first request, sending a second request for use by a network entity, the second request comprising: an identifier of an Application Function, the Application Function being associated with the first request; responsive to sending the second request, receiving user consent information; evaluating the user consent information for a service provided by the Application Function identified by the Application Function Identifier; and either: detecting that no user consent is granted to the service provided by the Application Function identified by the Application Function Identifier; and, responsive to detecting that no user consent is granted to the service, rejecting the establishment of the application session; or detecting that user consent is granted to the service provided by the Application Function identified by the Application Function Identifier; and, responsive to detecting that user consent is granted to the service, sending, to an Authentication and Key Management for Applications, AKMA, Anchor Function, AAnF, an AKMA application key request comprising the identifier of the Application Function.

There is provided an apparatus comprising: a transceiver; and a processor coupled to the transceiver, the processor and the transceiver configured to cause the apparatus to: receive a first request from an Application Function, the request comprising: an identifier of the Application Function; and an identifier for an Authentication and Key Management for Applications, AKMA, Anchor Key; responsive to receiving the first request, send a second request to an AKMA Anchor Function, AAnF, the second request comprising: the identifier for the AKMA Anchor Key; responsive to sending the second request, receive a Subscription Permanent Identifier, SUPI; responsive to receiving the SUPI, retrieve user consent information; and send the retrieved user consent information for use by the Application Function.

There is provided a method performed by an apparatus in a mobile network, the method comprising: receiving a first request from an Application Function, the request comprising: an identifier of the Application Function; and an identifier for an Authentication and Key Management for Applications, AKMA, Anchor Key; responsive to receiving the first request, sending a second request to an AKMA Anchor Function, AAnF, the second request comprising: the identifier for the AKMA Anchor Key; responsive to sending the second request, receiving a Subscription Permanent Identifier, SUPI; responsive to receiving the SUPI, retrieving user consent information; and sending the retrieved user consent information for use by the Application Function.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatuses for providing user consent information for data collection services will now be described, by way of example only, with reference to the accompanying drawings, in which:

FIG. 1 depicts an embodiment of a wireless communication system;

FIG. 1a illustrates certain steps of a UE requested data exposure procedure;

FIG. 2 depicts a user equipment apparatus;

FIG. 3 depicts a network node;

FIG. 4 illustrates certain steps of a method for providing user consent after primary authentication of the UE;

FIG. 5 illustrates certain steps of a method in which a user content check is performed;

FIG. 6 illustrates certain steps of a further method in which a user content check is performed;

FIG. 7 illustrates certain steps of a yet further method in which a user content check is performed;

FIG. 8 is a process flow chart showing certain steps of a method performed in the wireless communication system;

FIG. 9 is a process flow chart showing certain steps of a further method performed in the wireless communication system; and FIG. 10 is a process flow chart showing certain steps of a yet further method performed in the wireless communication system.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C. As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures. Like numbers refer to like elements in all Figures.

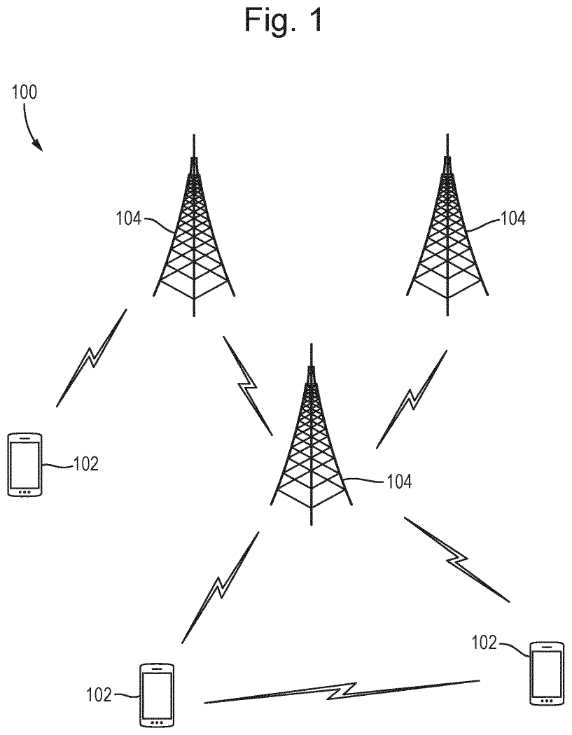

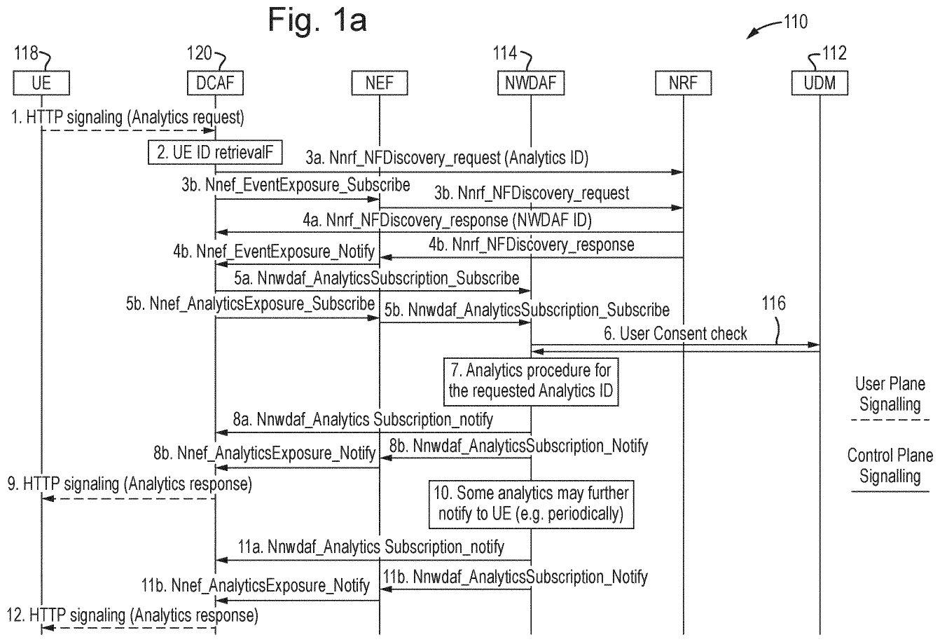

FIG. 1 depicts an embodiment of a wireless communication system 100 in which methods and apparatuses for providing user consent information for data collection services may be implemented. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an Access and Mobility Management Function (“AMF”), a Unified Data Management Function (“UDM”), a Unified Data Repository (“UDR”), a UDM/UDR, a Policy Control Function (“PCF”), a Radio Access Network (“RAN”), an Network Slice Selection Function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), an application function, a service enabler architecture layer (“SEAL”) function, a vertical application enabler server, an edge enabler server, an edge configuration server, a mobile edge computing platform function, a mobile edge computing application, an application data analytics enabler server, a SEAL data delivery server, a middleware entity, a network slice capability management server, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA2000, Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In the current study of TR 23.700-80, user consent is required for providing AI/ML analytics to the UE (e.g. a remote unit 102). One conventional solution for retrieving user consent (UC) for providing analytics data to the UE is shown in FIG. 1a.

FIG. 1a is a process flowchart showing certain steps of a UE requested data exposure procedure 110.

In the procedure 110, the user consent is queried from the UDM 112 by the NWDAF 114 in step 6 (which is indicated in FIG. 1a by the reference numeral 116). However, this step 116 occurs at a late stage in the procedure 110, after the UE 118 has already established a secure connection to the Application Function, AF (which in this case is a Data Collection Application Function, DCAF, 120) for this service. If there is no user consent for this service, then an overhead of unnecessary signalling in steps 2-8 would have taken place, and the rejection of the request would therefore consume unnecessary amount of network resources.

There are several solutions in the TR 23.700-80 that query the user consent for AI/ML analytics. However, all of them are linked to the NWDAF requesting user consent from the UDM. Thus, the user consent check is performed very late in the procedure. No solution in TR 23.700-80 takes into account the secure connection between UE and the AF, where the service is executed.

TR 33.867 studied various solutions with regard to user consent for different NFs requesting the user consent from the UDM. The solutions in TR 33.867 do not include the UE interaction, i.e. the UE requesting a service for which the user consent is required, like UE analytics. There is no solution that takes the user consent into account when setting up the secure connection for executing the service, i.e. checking the user consent in the first phase of the procedure.

The Authentication and Key Management for Applications (AKMA) procedure does not perform any user consent check for the service offered by the AF.

The present application presents a solution to this problem.

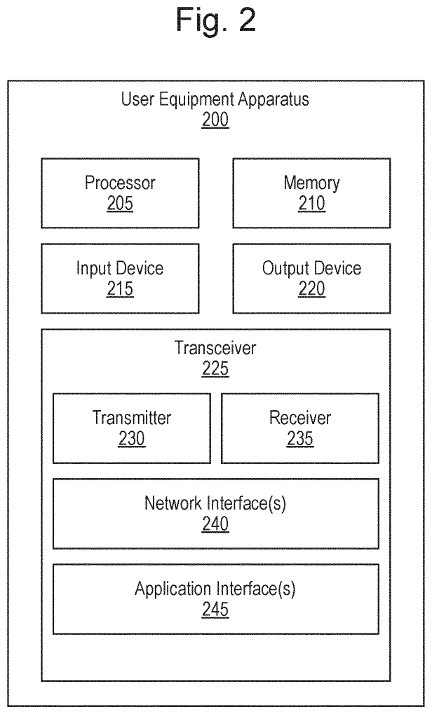

FIG. 2 depicts a user equipment apparatus 200 that may be used for implementing the methods described herein. The user equipment apparatus 200 is used to implement one or more of the solutions described herein. The user equipment apparatus 200 is in accordance with one or more of the user equipment apparatuses described in embodiments herein. In particular, the user equipment apparatus 200 may be in accordance with the remote unit 102 of FIG. 1 and/or the UE 118 of FIG. 1a. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the user equipment apparatus behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as described herein. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink communication signals to a base unit of a wireless communications network. Similarly, the one or more receivers 235 may be used to receive downlink communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

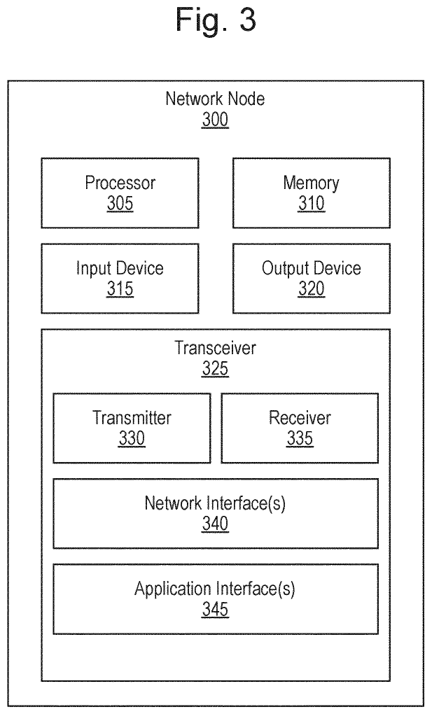

FIG. 3 depicts further details of the network node 300 that may be used for implementing the methods described herein. The network node 300 may be one implementation of an entity in the wireless communications network, e.g. in one or more of the wireless communications networks described herein, e.g. the wireless network 100 of FIG. 1. The network node 300 may be, for example, the UE apparatus 200 described above, or a Network Function (NF) or Application Function (AF), or another entity, of one or more of the wireless communications networks of embodiments described herein. For example, the network node 300 may be the same as the UE 118, the DCAF 120, the NEF, the NWDAF 114, the NRF, and/or the UDM 112 implemented in the procedure 110 shown in FIG. 1a. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described herein. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

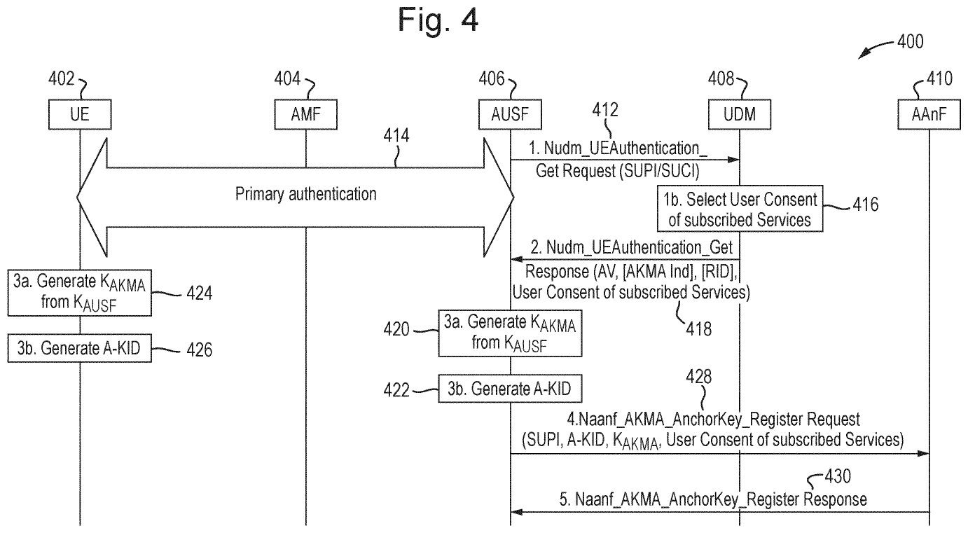

FIG. 4 is a process flow chart showing a method 400 for providing user consent after primary authentication of the UE, according to an embodiment.

The method 400 involves a UE 402, an Access and Mobility Management Function (AMF) 404, an Authentication Server Function (AUSF) 406, a UDM 408, and an AKMA Anchor Function (AAnF) 410.

The UE 402 may be the same as or in accordance with any of the UEs described herein, such as the UE 200 shown in FIG. 2 and described in more detail earlier above.

The AMF 404, the AUSF 406, a UDM 408, and the AAnF 410 may be the same as or in accordance with any network entity, function, or node described herein. For example, the AMF 404, the AUSF 406, a UDM 408, and/or the AAnF 410 may be the same as the network node 300 shown in FIG. 3 and described in more detail earlier above.

In this embodiment, the user consent is provided by the AUSF 406 for all the subscribed services to the AAnF 410. The AAnF 410 then checks the user consent for the service when the application function AF (or DCAF) requests a key from the AAnF 410. In case there is no user consent, the AF (or DCAF) will not receive the key and thus cannot establish the application session.

At step 412, during a primary authentication procedure 414, the AUSF 406 interacts with the UDM 408 in order to fetch authentication information such as subscription credentials (e.g. Authentication and Key Agreement (AKA) Authentication vectors) and the authentication method using the Nudm_UEAuthentication_Get Request service operation.

At step 416, the UDM 408 selects the user consent information for the subscribed services.

At step 418, in the response (i.e., in this embodiment, in the Nudm_UEAuthentication_Get Response service operation), the UDM 408 may indicate to the AUSF 406 whether the AKMA Anchor key (K_{AKMA}) needs to be generated for the UE 402 using an AKMA indication (AKMA Ind). If AKMA Ind is included in the response, the UDM 408 may also include the Registered Application Provider Identifier (RID) of the UE 402 and the user consent information of the subscribed services.

At step 420 and 422, if the AUSF 406 receives the AKMA indication, AKMA Ind, from the UDM 408, the AUSF 406 shall store an AUSF key (K_{AUSF}) and generate the AKMA Anchor Key, K_{AKMA}, and an identifier for K_{AKMA}, A-KID, from K_{AUSF} after the primary authentication procedure is successfully completed.

At steps 424 and 426, the UE 402 generates K_{AKMA} and the A-KID from K_{AUSF} before initiating communication with an AKMA Application Function.

At step 428, after AKMA key material (i.e., K_{AKMA} and the A-KID) is generated, the AUSF 406 selects the AAnF 410, and sends the generated A-KID and K_{AKMA} to the AAnF 410. In this embodiment, the generated A-KID and K_{AKMA} together with the Subscription Permanent Identifier (SUPI) of the UE 402 and the user consent information of the subscribed services. The generated A-KID and K_{AKMA}, the SUPI, and the user consent information of the subscribed services are sent using the Naanf_AKMA_KeyRegistration Request service operation.

The AAnF 410 stores the latest information sent by the AUSF 406.

In this embodiment, the AUSF 406 need not store any AKMA key material after it has been delivered to the AAnF 410.

In this embodiment, when re-authentication runs, the AUSF 406 generates a new A-KID, and a new K_{AKMA}, and sends the new generated A-KID and K_{AKMA} to the AAnF 410. After receiving the new generated A-KID and K_{AKMA}, the AAnF 410 may delete the old A-KID and K_{AKMA} and store the new generated A-KID and K_{AKMA}.

At step 430, the AAnF 410 sends a response to the AUSF 406 using the Naanf_AKMA_AnchorKey_Register Response service operation.

In this embodiment, the A-KID identifies the K_{AKMA} key of the UE 402.

In this embodiment, the A-KID may be in the Network Access Identifier (NAI) format, i.e. username@realm. The username part may include the RID and the AKMA Temporary UE Identifier (A-TID). The realm part may include a Home Network Identifier.

In this embodiment, the AUSF 406 may use the RID received from the UDM 408 to derive the A-KID.

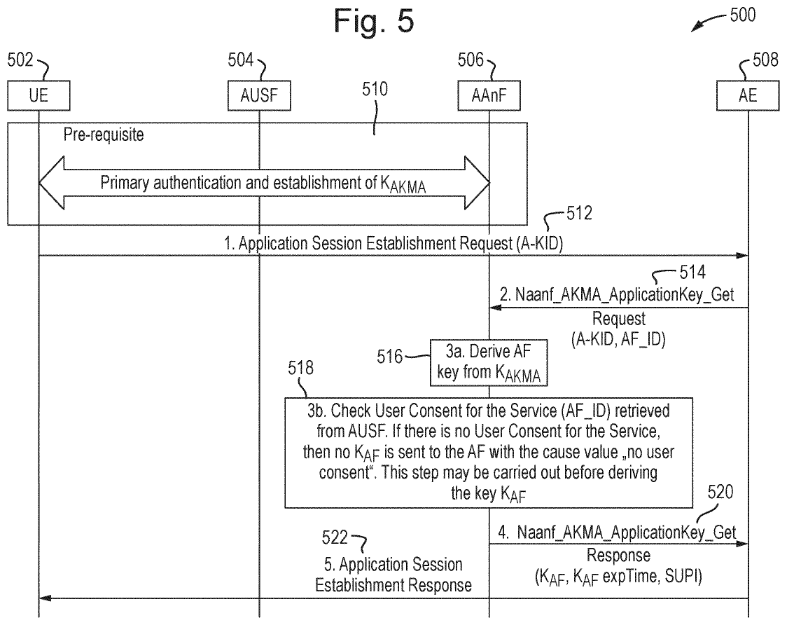

FIG. 5 is a process flow chart showing a method 500 in which a user content check is performed.

The method 500 of FIG. 5 may be performed after performance or completion of the method of FIG. 4, described in more detail earlier above.

The method 500 involves a UE 502, an AUSF 504, an AAnF 506, and an Application Function (AF) 508.

The UE 502 may be the same as or in accordance with any of the UEs described herein, such as the UE 200 shown in FIG. 2 and described in more detail earlier above. The UE 502 may be the same as or in accordance with the UE 402 of the method 400, shown in FIG. 4 and described in more detail earlier above.

The AUSF 504, the AAnF 506, and the AF 508 may be the same as or in accordance with any network entity, function, or node described herein. For example, the AUSF 504, the AAnF 506, and the AF 508 may be the same as the network node 300 shown in FIG. 3 and described in more detail earlier above. The AUSF 504 may be the same as or in accordance with the AUSF 406 of the method 400, shown in FIG. 4 and described in more detail earlier above. The AAnF 506 may be the same as or in accordance with the AAnF 410 of the method 400, shown in FIG. 4 and described in more detail earlier above.

In this embodiment, the method 500 is one in which user consent is checked in the AAnF 506 at the time of key request from AF 508.

At step 510, the UE 502 generates the AKMA Anchor Key, K_{AKMA}, and the A-KID from the K_{AUSF} before initiating communication with an AKMA Application Function, i.e. AF 508. This may be performed in accordance with the method 400, as described in more detail earlier above with reference to FIG. 4.

At step 512, the UE 502 initiates communication with the AKMA AF 508. In this embodiment, when the UE 502 initiates communication with the AKMA AF 508, it includes the derived A-KID in the Application Session Establishment Request message. The UE may derive an AKMA Application Key (K_{AF}) before or after sending the Request message.

At step 514, if the AF 508 does not have an active context associated with the A-KID, then the AF 508 selects the AAnF 506, and sends a Naanf_AKMA_ApplicationKey_Get Request to the AAnF 506. This Request comprises the A-KID to request the K_{AF} for the UE 502, and also the identity of the AF 508, AF_ID. In this embodiment, the AF_ID comprises or consists of the Fully Qualified Domain Name (FQDN) of the AF 508 and a Ua* security protocol identifier. More information on the Ua* security protocol identifier may be found in TS 33.535. The Ua* security protocol identifier identifies the security protocol that the AF 508 will use with the UE 502.

In this embodiment, the AAnF 506 checks whether the AAnF 506 can provide the service to the AF 508 based on a configured local policy or based on authorization information available in the signalling (e.g., Oauth2.0 token). If it succeeds, the following procedure steps are executed. Otherwise, the AAnF 506 rejects the procedure.

In this embodiment, the AAnF 506 verifies whether the subscriber is authorized to use AKMA based on the presence of the UE specific K_{AKMA} key identified by the A-KID.

If the K_{AKMA} is present in AAnF 506, the AAnF 506 continues by executing step 516.

However, if the K_{AKMA} is not present in the AAnF 506, the AAnF 506 may send an error response to the AF 508, e.g. using the Naanf_AKMA_ApplicationKey_Get response service operation.

At step 516, responsive to the AAnF 506 determining that K_{AKMA} is present in the AAnF 506, the AAnF 506 derives the AKMA Application Key, K_{AF}, from K_{AKMA} (if it does not already have K_{AF}).

At step 518, the AAnF 506 checks the user consent information for the service (corresponding to AF_ID) retrieved from the AUSF 504. If there is no user consent for the service, then no K_{AF} is sent to the AF 508. Also, the AAnF 506 may send an error response to the AF 508, e.g. using the Naanf_AKMA_ApplicationKey_Get response service operation. The error response may have a cause value of “no user consent” or may have a user consent result set to “not granted”. Optionally, this step (i.e. step 518) may be carried out before deriving the key K_{AF} (i.e. step 516).

Responsive to receiving an error response from the AAnF 506 at step 518, the AF 508 may reject the Application Session Establishment to the UE 502.

At step 520, the AAnF 506 sends a Naanf_AKMA_ApplicationKey_Get response to the AF 508. In this embodiment, this response comprise the SUPI, the K_{AF} and a K_{AF} expiration time.

At step 522, the AF 508 sends the Application Session Establishment Response to the UE 502.

As mentioned above, if the information received by the AF 508 from the AAnF 506 (i.e. in the Naanf_AKMA_ApplicationKey_Get response) indicates failure of the AKMA key request, the AF 508 rejects the Application Session Establishment by including a failure cause in the Application Session Establishment Response to the UE 502. Afterwards, the UE 502 may trigger a new Application Session Establishment request with the latest A-KID to the AKMA AF 508.

However, if the information received by the AF 508 from the AAnF 506 (i.e. in the Naanf_AKMA_ApplicationKey_Get response) indicates success of the AKMA key request, e.g. by including the K_{AF}, K_{AF} expiration time and SUPI, the AF 508 accepts the Application Session Establishment with the UE 502. Thus, an Application Session may be established between the UE 502 and the AKMA AF 508.

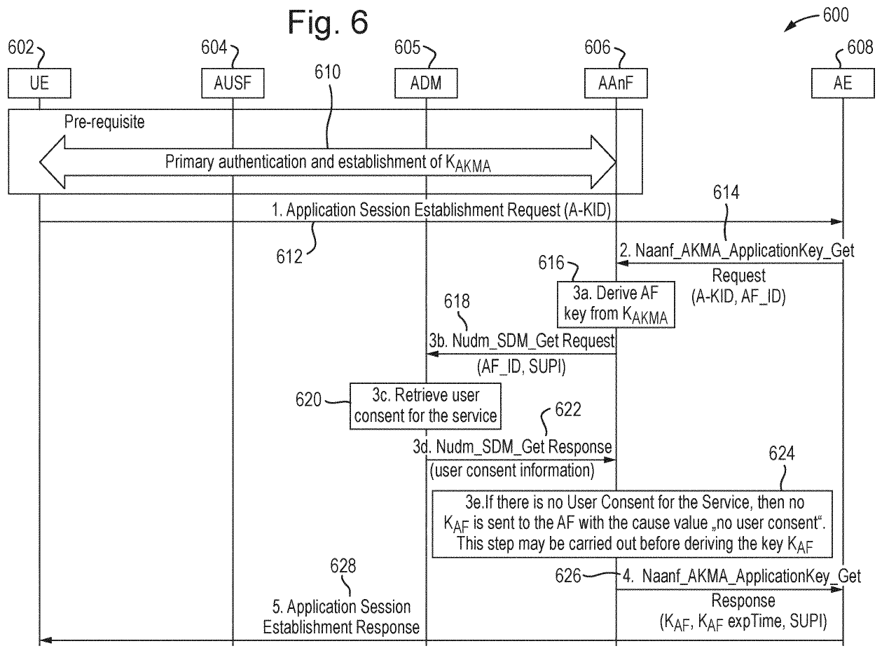

FIG. 6 is a process flow chart showing a method 600 in which a user content check is performed.

The method 600 of FIG. 6 may be performed after performance or completion of the method of FIG. 4, described in more detail earlier above.

The method 600 involves a UE 602, an AUSF 604, a UDM 605, an AAnF 606, and an AF 608.

The UE 602 may be the same as or in accordance with any of the UEs described herein, such as the UE 200 shown in FIG. 2 and described in more detail earlier above. The UE 602 may be the same as or in accordance with the UE 402 of the method 400 shown in FIG. 4 and described in more detail earlier above.

The AUSF 604, the UDM 605, the AAnF 606, and/or the AF 608 may be the same as or in accordance with any network entity, function, or node described herein. For example, the AUSF 604, the UDM 605, the AAnF 606, and/or the AF 608 may be the same as the network node 300 shown in FIG. 3 and described in more detail earlier above. The AUSF 604 may be the same as or in accordance with the AUSF 406 of the method 400, shown in FIG. 4 and described in more detail earlier above. The UDM 605 may be the same as or in accordance with the UDM 408 of the method 400, shown in FIG. 4 and described in more detail earlier above. The AAnF 606 may be the same as or in accordance with the AAnF 410 of the method 400, shown in FIG. 4 and described in more detail earlier above.

In this embodiment, the AAnF 606 queries the UDM 605 at the time of the key request for the user consent of the service from the AF 608, identified with the AF-ID. An additional Service ID may be utilized if the AF 608 is hosting different services to identify the service uniquely in the UDM 605. The UDM 605 provides the user consent information to the AAnF 606, and the AAnF 606 checks whether user consent is given for the service (identified by AF-ID and/or Service ID) and decides whether to derive an AF key or not.

At step 610, the UE 602 may generate the AKMA Anchor Key, K_{AKMA}, and the A-KID from the K_{AUSF} before initiating communication with the Application Function, i.e. AF 608. This may be performed in accordance with the method 400, as described in more detail earlier above with reference to FIG. 4. In this embodiment, before communication between the UE 602 and the AKMA AF 608 starts, the UE 602 and the AKMA AF 608 know whether to use AKMA. This knowledge may be implicit to the specific application on the UE 602 and the AKMA AF 608, or may be indicated by the AKMA AF 608 to the UE 602.

In this embodiment, the UE 602 generates the AKMA Anchor Key, K_{AKMA}, and the A-KID from the K_{AUSF} before initiating communication with an AKMA Application Function 608.

At step 612, the UE 602 initiates communication with the AKMA AF 608. The UE 602 includes the derived A-KID in the Application Session Establishment Request message sent to the AF 608. The UE 602 may derive K_{AF} before sending the message or afterwards.

At step 614, if the AF 608 does not have an active context associated with the A-KID, then the AF 608 selects the AAnF 606, and sends a Naanf_AKMA_ApplicationKey_Get request to the AAnF 606. This request comprises the A-KID to request the K_{AF} for the UE 602. The AF 608 also includes its identity (AF_ID) in the request.

In this embodiment, the AF_ID comprises the FQDN of the AF 608 and the Ua* security protocol identifier. The Ua* security protocol identifier identifies the security protocol that the AF 608 will use with the UE 602.

In this embodiment, the AAnF 606 checks whether the AAnF 606 can provide the service to the AF 608 based on the configured local policy and/or based on the authorization information available in the signalling (i.e., Oauth2.0 token). If it succeeds, the following procedures are executed. Otherwise, the AAnF 606 reject the procedures.

In this embodiment, the AAnF 606 verifies whether the subscriber is authorized to use AKMA based on the presence of the UE specific K_{AKMA} key identified by the A-KID.

If the K_{AKMA} is present in the AAnF 606, the AAnF 606 continues by executing step 616.

However, if the K_{AKMA} is not present in the AAnF 606, the AAnF 606 may send an error response to the AF 608, e.g. using the Naanf_AKMA_ApplicationKey_Get response service operation.

At step 616, responsive to the AAnF 606 determining that K_{AKMA} is present in the AAnF 606, the AAnF 606 derives the AKMA Application Key, K_{AF}, from K_{AKMA} (if it does not already have K_{AF}).

At step 618, the AAnF 606 decides to query for the user consent of the service and sends a Nudm_SDM_Get_Request with the AF-ID and the SUPI to the UDM 605. The AAnF 606 may include a Service ID, if available, and indicates that the user consent information for the service is requested.

At step 620, the UDM 605 uses the SUPI to retrieve the user consent information for the service, identified with the AF-ID and/or the Service ID.

At step 622, the UDM 605 sends a Nudm_SDM_Get_Response with the user consent information for the service to the AAnF 606.

At step 624, the AAnF 506 checks the user consent information for the service (corresponding to AF_ID) retrieved from the AUSF 604. If there is no user consent for the service, then no K_{AF} is sent to the AF 608. Also, the AAnF 606 may send an error response to the AF 608, e.g. using the Naanf_AKMA_ApplicationKey_Get response service operation. The error response may have a cause value of “no user consent” or may have a user consent result set to “not granted”. Optionally, this step (i.e. step 624) may be carried out before deriving the key K_{AF} (i.e. step 616).

Responsive to receiving an error response from the AAnF 606 at step 624, the AF 608 may reject the Application Session Establishment to the UE 602.

However, if there is user consent for the service, at step 626, the AAnF 506 sends a Naanf_AKMA_ApplicationKey_Get response to the AF 608. In this embodiment, this response comprises the SUPI, the K_{AF} and a K_{AF} expiration time.

At step 628, the AF 608 sends the Application Session Establishment Response to the UE 602.

As mentioned above, if the information received by the AF 608 from the AAnF 606 (i.e. in the Naanf_AKMA_ApplicationKey_Get response) indicates failure of the AKMA key request, the AF 608 rejects the Application Session Establishment by including a failure cause in the Application Session Establishment Response to the UE 602. Afterwards, the UE 602 may trigger a new Application Session Establishment request with the latest A-KID to the AKMA AF 608.

However, if the information received by the AF 608 from the AAnF 606 (i.e. in the Naanf_AKMA_ApplicationKey_Get response) indicates success of the AKMA key request, e.g. by including the KAF, KAF expiration time and SUPI, the AF 608 accepts the Application Session Establishment with the UE 602. Thus, an Application Session may be established between the UE 602 and the AKMA AF 608.

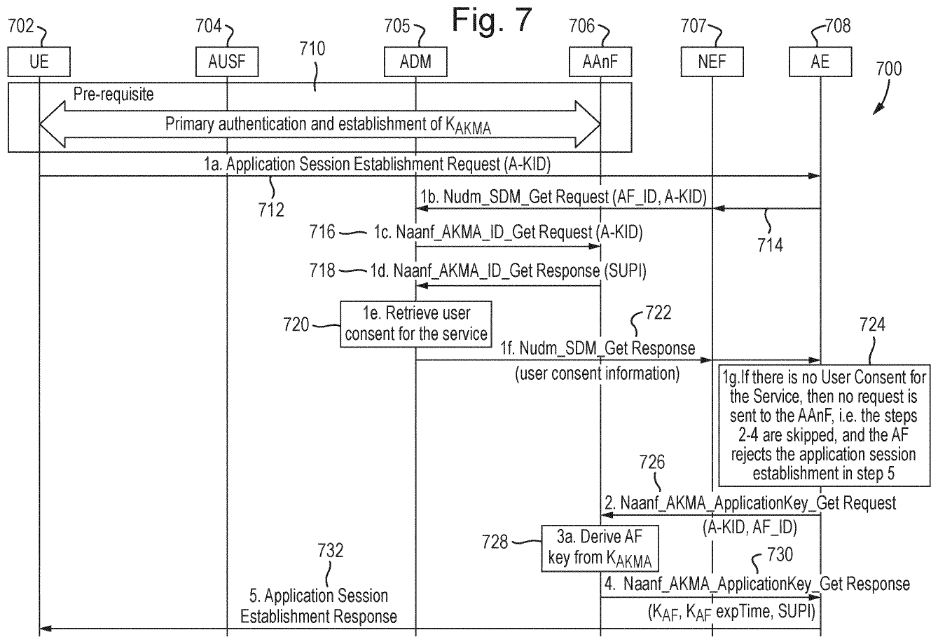

FIG. 7 is a process flow chart showing a method 700 in which a user content check is performed.

The method 700 of FIG. 7 may be performed after performance or completion of the method of FIG. 4, described in more detail earlier above.

The method 700 involves a UE 702, an AUSF 704, a UDM 705, an AAnF 706, an NEF 707, and an AF 708.

The UE 702 may be the same as or in accordance with any of the UEs described herein, such as the UE 200 shown in FIG. 2 and described in more detail earlier above. The UE 702 may be the same as or in accordance with the UE 402 of the method 400 shown in FIG. 4 and described in more detail earlier above.

The AUSF 704, the UDM 705, the AAnF 706, the NEF 707, and/or the AF 708 may be the same as or in accordance with any network entity, function, or node described herein. For example, AUSF 704, the UDM 705, the AAnF 706, the NEF 707, and/or the AF 708 may be the same as the network node 300 shown in FIG. 3 and described in more detail earlier above. The AUSF 704 may be the same as or in accordance with the AUSF 406 of the method 400, shown in FIG. 4 and described in more detail earlier above. The UDM 705 may be the same as or in accordance with the UDM 408 of the method 400, shown in FIG. 4 and described in more detail earlier above. The AAnF 706 may be the same as or in accordance with the AAnF 410 of the method 400, shown in FIG. 4 and described in more detail earlier above.

In this embodiment, the AF 708 queries the UDM 705 for the user consent information for the service it is offering at the time it receives the Application Session Establishment Request from the UE 702, identified with the A-KID. The AF 708 then checks whether to setup the application session, based on the received user consent information from the UDM 705.

At step 710, the UE 702 may generate the AKMA Anchor Key, K_{AKMA}, and the A-KID from the K_{AUSF} before initiating communication with the Application Function, i.e. AF 708. This may be performed in accordance with the method 400, as described in more detail earlier above with reference to FIG. 4. In this embodiment, before communication between the UE 702 and the AKMA AF 708 starts, the UE 702 and the AKMA AF 708 know whether to use AKMA. This knowledge may be implicit to the specific application on the UE 702 and the AKMA AF 708, or may be indicated by the AKMA AF 708 to the UE 702.

In this embodiment, the UE 702 generates the AKMA Anchor Key, K_{AKMA}, and the A-KID from the K_{AUSF} before initiating communication with an AKMA Application Function 708.

At step 712, the UE 602 initiates communication with the AKMA AF 708. The UE 702 includes the derived A-KID in the Application Session Establishment Request message sent to the AF 708. The UE 702 may derive K_{AF} before sending the message or afterwards.

At step 714, the AF 708 decides to query for the user consent of the service and sends a Nudm_SDM_Get_Request with the AF-ID and the A-KID to the UDM 705. The AF 708 may include a Service ID, if available, and indicates that the user consent information for the service is requested. The request message may be sent via the NEF 707.

At step 716, the UDM 705 does not have the binding of A-KID to SUPI and sends a Naanf_AKMA_ID_Get_Request with the A-KID to the AAnF 706.

At step 718, the AAnF 706 selects the corresponding SUPI which is linked to the A-KID and sends the SUPI to the UDM 705 in a Naanf_AKMA_ID_Get_Response.

At step 720, the UDM 705 uses the SUPI to retrieve the user consent information for the service, identified with the AF-ID and/or the Service ID.

At step 722, the UDM 705 sends a Nudm_SDM_Get_Response with the UC parameters for the service to the AF 708. The message may be sent via the NEF 707.

At step 724, the AF 708 checks the user consent information for the service retrieved from the UDM 705.

If there is no user consent for the service, then no Application Session will be established. Also, generation of the key K_{AF} may be omitted. The AF 708 may reject the Application Session Establishment to the UE 702. The AF 708 may send an error response to the UE 702 having a cause value of “no user consent” or may have a user consent result set to “not granted”. Optionally, this step (i.e. step 724) may be carried out before deriving the key K_{AF} (i.e. step 616).

However, if there is user consent for the service, at step 726, if the AF 708 does not have an active context associated with the A-KID, then the AF 708 selects the AAnF 706, and sends a Naanf_AKMA_ApplicationKey_Get request to AAnF 706 with the A-KID to request the K_{AF} for the UE 702. The AF 708 may also include its identity (AF_ID) in the request.

In his embodiment, the AF_ID comprises the FQDN of the AF 708 and the Ua* security protocol identifier. The Ua* security protocol identifier identifies the security protocol that the AF 708 will use with the UE 702.

In his embodiment, the AAnF 706 checks whether the AAnF 706 can provide the service to the AF 708 based on the configured local policy or based on the authorization information available in the signalling (i.e., Oauth2.0 token). If it succeeds, the following procedures are executed. Otherwise, the AAnF 706 rejects the procedure.

In his embodiment, the AAnF 706 verifies whether the subscriber is authorized to use AKMA based on the presence of the UE specific K_{AKMA} key identified by the A-KID.

If the K_{AKMA} is present in the AAnF 606, the AAnF 606 continues by executing step 728.

However, if the K_{AKMA} is not present in the AAnF 706, the AAnF 706 may send an error response to the AF 708, e.g. using the Naanf_AKMA_ApplicationKey_Get response service operation.

At step 728, responsive to the AAnF 606 determining that K_{AKMA} is present in the AAnF 606, the AAnF 606 derives the AKMA Application Key, K_{AF}, from K_{AKMA} (if it does not already have K_{AF}).

At step 730, the AAnF 706 sends Naanf_AKMA_ApplicationKey_Get response to the AF 708 with SUPI, K_{AF} and the K_{AF} expiration time.

At step 732, the AF 708 sends the Application Session Establishment Response to the UE 702.

As mentioned above, if the information received by the AF 708 from the AAnF 706 (i.e. in the Naanf_AKMA_ApplicationKey_Get response) indicates failure of the AKMA key request, the AF 708 rejects the Application Session Establishment by including a failure cause in the Application Session Establishment Response to the UE 702. Afterwards, the UE 702 may trigger a new Application Session Establishment request with the latest A-KID to the AKMA AF 708.

However, if the information received by the AF 708 from the AAnF 706 (i.e. in the Naanf_AKMA_ApplicationKey_Get response) indicates success of the AKMA key request, e.g. by including the KAF, KAF expiration time and SUPI, the AF 708 accepts the Application Session Establishment with the UE 702. Thus, an Application Session may be established between the UE 702 and the AKMA AF 708.

In the current study of TR 23.700-80, user consent is required for providing AI/ML analytics to the UE. There are several solutions in the TR 23.700-80 that are querying the user consent for AI/ML analytics, but they tend to be linked to the NWDAF requesting user consent from the UDM. Thus, the user consent check is performed very late in the procedure. If there is no user consent for this service, then an overhead of unnecessary signalling would take place and the rejection of the original UE request would therefore consume unnecessary network resources.

Advantageously, in the embodiments described herein, the user consent is checked at the time of establishment of the secure connection between UE and AF, before any of the procedures in TR 23.700-80 are executed. If there is no user consent, the secure connection will fail, thus the procedure is terminated in the beginning without wasting any other resources.

There are several solutions in the TR 23.700-80 that query the user consent for AI/ML analytics, they tend to be linked to the NWDAF requesting user consent from the UDM. No solution in TR 23.700-80 takes into account the secure connection between UE and the AF, where the service is executed. TR 33.867 studied various solutions on user consent for different NFs requesting the user consent from the UDM. The solutions in TR 33.867 do not include the UE interaction, i.e. the UE requesting a service for which the user consent is required, like UE analytics. There is no solution that takes the user consent into account when setting up the secure connection for executing the service, i.e. checking the user consent in the first phase of the procedure. The AKMA procedure for setting up a secure connection does not perform any user consent check for the service offered by the AF.

In an embodiment, user consent is provided by the AUSF for all the subscribed services to the AAnF. The AAnF then checks the UC for the service when the application function AF (or DCAF) requests a key from the AAnF. In case there is no user consent, the AF (or DCAF) will not receive the key and thus cannot establish the application session.

In another embodiment, the AAnF queries the UDM at the time of the key request for the UC of the service from the AF, identified with the AF-ID. An additional Service ID may be utilized if the AF is hosting different services to identify the service uniquely in the UDM. The UDM provides the UC to the AAnF and the AAnF checks whether UC is given for the service (identified by AF-ID and/or Service ID) and decides whether to derive an AF key or not.

In another embodiment, the AF queries the UDM for the UC information for the service it is offering at the time it receives the Application Session Establishment Request from the UE, identified with the A-KID. The AF then checks whether to setup the application session, based on the received UC information from the UDM.

In an embodiment, there is provided an apparatus (e.g. an AAnF) comprising a transceiver and a processor coupled to the transceiver. The processor and the transceiver are configured to cause the apparatus to receive an Authentication and Key Management for Applications, AKMA, application key request from an Application Function (which may be on another apparatus). The AKMA application key request comprises an identifier of the Application Function (AF_ID). The processor and the transceiver are configured to cause the apparatus to: acquire user consent information; evaluate the user consent information for a service provided by the Application Function identified by the Application Function Identifier; detect that no user consent is granted to the service provided by the Application Function identified by the Application Function Identifier; and, responsive to detecting that no user consent is granted to the service, send, in response to the AKMA application key request, to the Application Function, a first AKMA application key response message indicating that no user consent is granted to the service.

The first AKMA application key response message may omit a first security key, which may be an AKMA Application Key, K_{AF}.

The processor and the transceiver may be further configured to cause the apparatus to: detect that user consent is granted to the service provided by the Application Function identified by the Application Function Identifier; and, responsive to detecting that user consent is granted to the service, send, in response to the AKMA application key request, to the Application Function, a second AKMA application key response message comprising a first security key, which may be the AKMA Application Key, K_{AF}.

The processor and the transceiver may be further configured to cause the apparatus to derive the first security key (which may be the AKMA Application Key, KAF) from a second security key (which may be the AKMA Anchor Key, K_{AKMA}). This derivation may be performed in response to detecting that user consent is granted to the service.

The first AKMA application key response message may comprise a cause value “no user consent” or a user consent result set to “not granted”.

The apparatus may be an AKMA Anchor Function, AAnF.

In some embodiments (such as that described in more detail earlier above with reference to FIGS. 4 and 5), the processor and the transceiver are further configured to cause the apparatus to receive the user consent information from an Authentication Server Function, AUSF, which may be on another apparatus. The user consent information may be received from the AUSF in a key registration request message that may, for example, further comprises one or more of: a second security key (such as the AKMA Anchor Key (K_{AKMA}), an identifier for the second security key (i.e. an identifier for K_{AKMA}, i.e. A-KID); and/or a Subscription Permanent Identifier, SUPI.

In some embodiments (such as that described in more detail earlier above with reference to FIG. 6), the processor and the transceiver are further configured to cause the apparatus to: send a user consent request to a United Data Management, UDM, function (which may be on another apparatus); and receive, in response to the user consent request, from the UDM, the user consent information. The user consent request may comprise the identifier of the Application Function, AF_ID. The AKMA application key request may further comprise an identifier for a second security key (e.g. an identifier for K_{AKMA}, i.e. A-KID]. The processor and the transceiver may be further configured to cause the apparatus to select a Subscription Permanent Identifier, SUPI, based on the identifier for the second security key (e.g. A-KID). The user consent request may further comprise the SUPI.

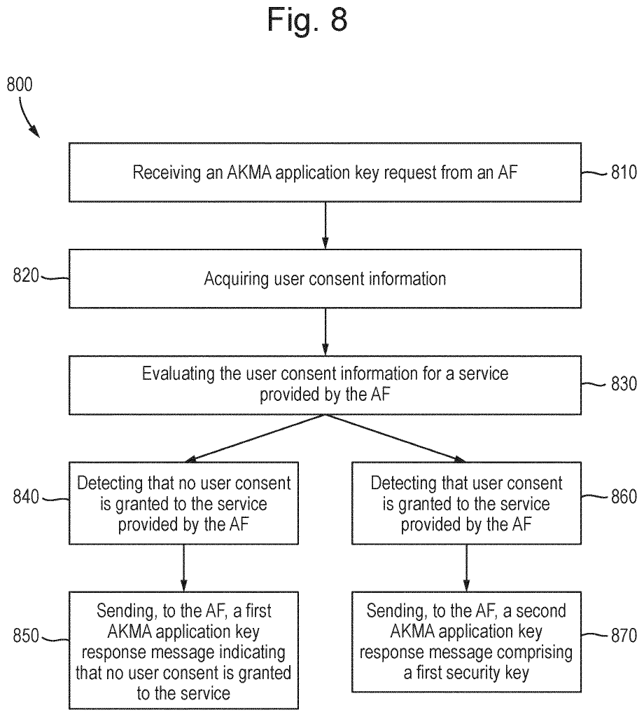

In an embodiment, there is provided a method performed by an apparatus in a mobile network. The apparatus may be an AAnF, such as an AAnF as disclosed herein, e.g. an AAnF 410, 506, 606, 706 as described in more detail earlier above. FIG. 8 is a process flow chart showing this method 800. The method 800 comprises: receiving 810 an Authentication and Key Management for Applications, AKMA, application key request from an Application Function, which my be on another apparatus. The AKMA application key request comprises an identifier of the Application Function (e.g. AF_ID). The method 800 further comprises: acquiring 820 user consent information; evaluating 830 the user consent information for a service provided by the Application Function identified by the Application Function Identifier; and either: detecting 840 that no user consent is granted to the service provided by the Application Function identified by the Application Function Identifier; and, responsive to detecting that no user consent is granted to the service, sending 850, in response to the AKMA application key request, to the Application Function, a first AKMA application key response message indicating that no user consent is granted to the service; or detecting 860 that user consent is granted to the service provided by the Application Function identified by the Application Function Identifier; and, responsive to detecting that user consent is granted to the service, sending 870, in response to the AKMA application key request, to the Application Function, a second AKMA application key response message comprising a first security key (e.g. an AKMA Application Key, K_{AF}).

In a further embodiment, there is provided an apparatus (e.g. an AF, such as an AKMA AF) comprising a transceiver, and a processor coupled to the transceiver. The processor and the transceiver are configured to cause the apparatus to: receive, from a user equipment, UE, apparatus, a first request, the first request being a request to establish an application session; responsive to receiving the first request, send (e.g. via another network entity such as a NEF) a second request (such as a Nudm_SDM_Get_Request) for use by a network entity (which may be on another apparatus). The second request comprises: an identifier of an Application Function, AF (e.g., AF_ID). The AF is associated with the first request, and may the apparatus. The processor and the transceiver are configured to cause the apparatus to: responsive to sending the second request, receive user consent information; evaluate the user consent information for a service provided by the AF identified by the AF Identifier; detect that no user consent is granted to the service provided by the AF identified by the AF Identifier; and, responsive to detecting that no user consent is granted to the service, rejecting (e.g. opposing or preventing) the establishment of the application session, e.g. the application session between the UE and the AF.

The processor and the transceiver may be further configured to cause the apparatus to, responsive to detecting that no user consent is granted to the service, send to the UE apparatus, a first response message indicating that no user consent is granted to the service. The first response message may comprise a cause value “no user consent” or a user consent result set to “not granted”.

The processor and the transceiver may be further configured to cause the apparatus to: detect that user consent is granted to the service provided by the Application Function identified by the Application Function Identifier; and, responsive to detecting that user consent is granted to the service, send, to an Authentication and Key Management for Applications, AKMA, Anchor Function, AAnF, (which may be on another apparatus) an AKMA application key request comprising the identifier of the Application Function.

The first request may comprise an identifier (e.g. A-KID) for an AKMA Anchor Key, K_{AKMA}. The second request may comprise an identifier (e.g. A-KID) for an AKMA Anchor Key, K_{AKMA}.

The AKMA application key request may also comprise the identifier, A-KID, for the AKMA Anchor Key, K_{AKMA}.

The network entity may be a United Data Management, UDM, network entity.

The user consent information may be received from the network entity, e.g. via another network entity such as a NEF.

The apparatus may be the Application Function.

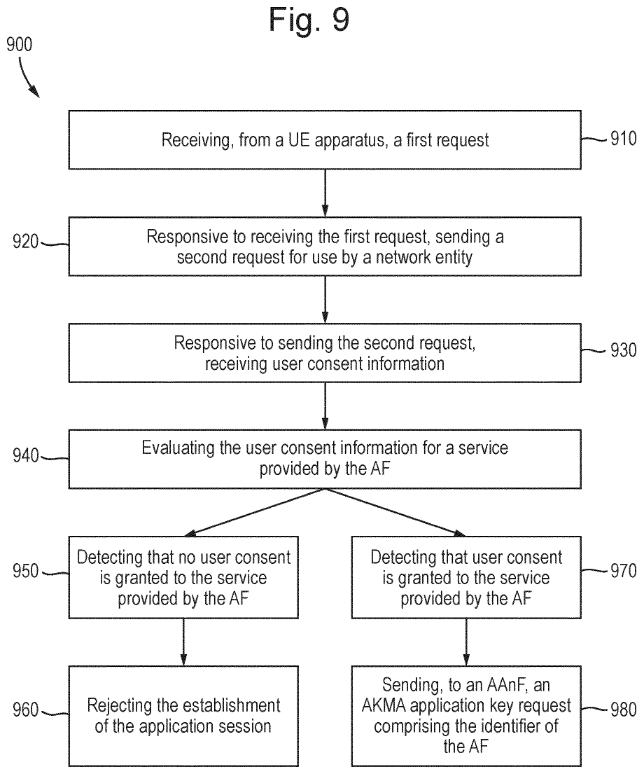

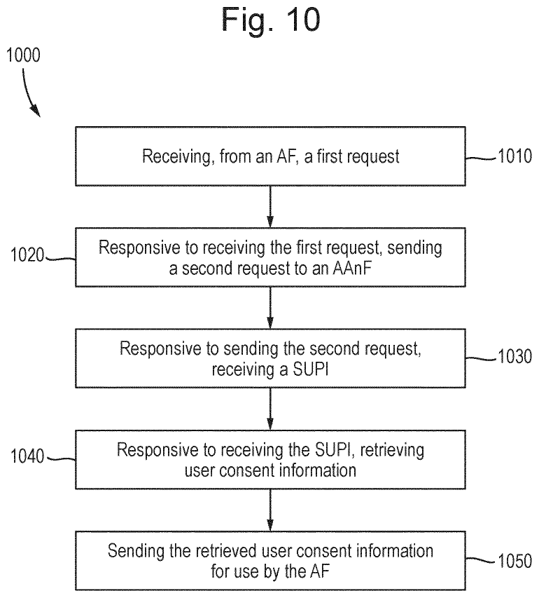

In an embodiment, there is provided a method performed by an apparatus in a mobile network. The apparatus may be an AF, such as an AF as disclosed herein, e.g. an AF 508, 608, 708 as described in more detail earlier above. FIG. 9 is a process flow chart showing this method 900. The method 900 comprises: receiving 910, from a user equipment, UE, apparatus, a first request, the first request being a request to establish an application session; and, responsive to receiving the first request, sending 920 a second request (e.g. Nudm_SDM_Get_Request) for use by a network entity (which may be on another apparatus). The second request comprises: an identifier of an Application Function (e.g. AF_ID), the Application Function being associated with the first request. The method 900 further comprises: responsive to sending the second request, receiving 930 user consent information; evaluating 940 the user consent information for a service provided by the Application Function identified by the Application Function Identifier; and either: detecting 950 that no user consent is granted to the service provided by the Application Function identified by the Application Function Identifier; and, responsive to detecting that no user consent is granted to the service, rejecting 960 the establishment of the application session; or detecting 970 that user consent is granted to the service provided by the Application Function identified by the Application Function Identifier; and, responsive to detecting that user consent is granted to the service, sending 980, to an Authentication and Key Management for Applications, AKMA, Anchor Function, AAnF, an AKMA application key request comprising the identifier of the Application Function (AF_ID).

In an embodiment, there is provided an apparatus (e.g. a UDM) comprising a transceiver, and a processor coupled to the transceiver. The processor and the transceiver are configured to cause the apparatus to receive a first request (e.g. a Nudm_SDM_Get_Request) from an Application Function, which may be on another apparatus. The request comprises an identifier of the Application Function (e.g. AF_ID), and an identifier (e.g. A-KID) for an Authentication and Key Management for Applications, AKMA, Anchor Key (e.g. K_{AKMA}). The processor and the transceiver are configured to cause the apparatus to, responsive to receiving the first request, send a second request (e.g. a Naanf_AKMA_ID_Get_Request), to an AKMA Anchor Function, AAnF, which may be on another apparatus. The second request comprises: the identifier (e.g. A-KID) for the AKMA Anchor Key (e.g. K_{AKMA}). The processor and the transceiver are configured to cause the apparatus to: responsive to sending the second request, receive a Subscription Permanent Identifier, SUPI; responsive to receiving the SUPI, retrieve user consent information; and send the retrieved user consent information for use by the Application Function (i.e. identified by the identifier of the Application Function).

The apparatus is a United Data Management, UDM, network entity.

In an embodiment, there is provided a method performed by an apparatus in a mobile network. The apparatus may be a UDM, such as a UDM as disclosed herein, e.g. a UDM 408, 605, 705 as described in more detail earlier above. FIG. 10 is a process flow chart showing this method 1000. The method 1000 comprises: receiving 1010 a first request (e.g. Nudm_SDM_Get_Request) from an Application Function (which may be on another apparatus), the request comprising: an identifier of the Application Function (e.g. AF_ID); and an identifier (e.g. A-KID) for an Authentication and Key Management for Applications, AKMA, Anchor Key (e.g. K_{AKMA}). The method 1000 further comprises, responsive to receiving the first request, sending 1020 a second request (e.g. Naanf_AKMA_ID_Get_Request) to an AKMA Anchor Function, AAnF, which may be on another apparatus. The second request comprises: the identifier (e.g. A-KID) for the AKMA Anchor Key. The method 1000 further comprises: responsive to sending the second request, receiving 1030 a Subscription Permanent Identifier, SUPI; responsive to receiving the SUPI, retrieving 1040 user consent information; and sending the retrieved user consent information for use by the Application Function.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communications standards, these examples are not intended to be the limit of the communications standards to which the disclosed method and apparatus may be applied. For example, while specific examples have been given in the context of 3GPP, the principles disclosed herein can also be applied to another wireless communications system, and indeed any communications system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.
AAnF AKMA Anchor Function
ADRF Analytics Data Repository Function
AF Application Function
AI Artificial Intelligence
A-KID AKMA Key Identifier
AKMA Authentication and Key Management for Applications
AnLF Analytics logical function
DCAF Data Collection Application Function
DCCF Data Collection Coordination Function
FQDN Fully Qualified Domain Name
MFAF Managing Framework Adaptor Function
ML Machine Learning
MTLF Model Training logical function
NF Network Function
NFc NF consumer
NFp NF producer
NRF Network Function Repository Function
NWDAF Network Data Analytics Function
SUPI Subscription Permanent Identifier
UC User Consent
UDM United Data Management

1. An apparatus for wireless communication, comprising:
at least one memory; and
at least one processor coupled with the at least one memory and configured to cause the apparatus to:
receive an authentication and key management for applications (AKMA) application key request from an application function (AF), the AKMA application key request comprising an AF identifier of the AF;
acquire user consent information;
evaluate the user consent information for a service provided by the AF identified by the AF identifier;
detect that no user consent is granted to the service provided by the AF identified by the AF identifier; and
responsive to detection that no user consent is granted to the service, send to the AF in response to the AKMA application key request, a first AKMA application key response message indicating that no user consent is granted to the service.

2. The apparatus of claim 1, wherein the first AKMA application key response message omits a first security key.

3. The apparatus of claim 1, wherein the at least one processor is configured to cause the apparatus to:
detect that user consent is granted to the service provided by the AF identified by the AF identifier; and
responsive to detection that the user consent is granted to the service, send to the AF in response to the AKMA application key request, a second AKMA application key response message comprising a first security key.

4. The apparatus of claim 3, wherein the at least one processor is configured to cause the apparatus to derive the first security key from a second security key based at least in part on the detection that the user consent is granted to the service.

5. The apparatus of claim 1, wherein the first AKMA application key response message comprises at least one of a cause value that indicates the no user consent, or a user consent result that indicates the user consent is not granted.

6. The apparatus of claim 1, wherein the apparatus is an AKMA anchor function (AAnF).

7. The apparatus of claim 1, wherein the at least one processor is configured to cause the apparatus to receive the user consent information from an authentication server function (AUSF).

8. The apparatus of claim 7, wherein the user consent information is received from the AUSF in a key registration request message that comprises one or more of a security key, an identifier of the security key, or a subscription permanent identifier (SUPI).

9. The apparatus of claim 1, wherein the at least one processor is configured to cause the apparatus to:
send a user consent request to a united data management (UDM) function, the user consent request comprising the AF identifier; and
receive, from the UDM in response to the user consent request, the user consent information.

10. The apparatus of claim 9, wherein:
the AKMA application key request further comprises an identifier of a second security key;
the at least one processor is configured to cause the apparatus to select a subscription permanent identifier (SUPI) based on the identifier of the second security key; and
the user consent request further comprises the SUPI.

11. A method performed by an apparatus, the method comprising:
receiving an authentication and key management for applications (AKMA) application key request from an application function (AF), the AKMA application key request comprising an AF identifier of the AF;
acquiring user consent information;
evaluating the user consent information for a service provided by the AF identified by the AF identifier; and either:
detecting that no user consent is granted to the service provided by the AF identified by the AF identifier; and
responsive to detecting that no user consent is granted to the service, sending to the AF in response to the AKMA application key request, a first AKMA application key response message indicating that no user consent is granted to the service; or
detecting that user consent is granted to the service provided by the AF identified by the AF identifier; and
responsive to detecting that the user consent is granted to the service, send to the AF in response to the AKMA application key request, a second AKMA application key response message comprising a first security key.

12. An apparatus comprising:
at least one memory; and
at least one processor coupled with the at least one memory and configured to cause the apparatus to:
receive, from a user equipment (UE), a first request to establish an application session;
responsive to receiving the first request, send a second request for use by a network entity, the second request comprising an application function (AF) identifier of an Application AF associated with the first request;
responsive to sending the second request, receive user consent information;
evaluate the user consent information for a service provided by the AF identified by the AF identifier;
detect that no user consent is granted to the service provided by the AF identified by the AF identifier; and
responsive to detection that no user consent is granted to the service, reject establishment of the application session.

13. The apparatus of claim 12, wherein the at least one processor is configured to cause the apparatus to, responsive to the detection that no user consent is granted to the service, send to the UE, a first response message indicating that no user consent is granted to the service.

14. The apparatus of claim 13, wherein the first response message comprises at least one of a cause value that indicates the no user consent, or a user consent result that indicates the user consent is not granted.

15. The apparatus of claim 12, wherein the at least one processor is configured to cause the apparatus to:
detect that user consent is granted to the service provided by the AF identified by the AF identifier; and
responsive to detecting that the user consent is granted to the service, send to an authentication and key management for applications (AKMA) anchor function (AAnF), an AKMA application key request comprising the AF identifier of the AF.

16. The apparatus of claim 12, wherein:
the first request comprises an identifier of an authentication and key management for applications (AKMA) anchor key; and
the second request comprises the identifier of the AKMA anchor key.

17. The apparatus of claim 12, wherein the network entity is a united data management (UDM) network entity.

18. The apparatus of claim 12, wherein the user consent information is received from the network entity.

19. The apparatus of claim 12, wherein the apparatus is the AF.

20. (canceled)

21. An apparatus comprising:
at least one memory; and
at least one processor coupled with the at least one memory and configured to cause the apparatus to:
receive a first request from an application function (AF), the request comprising an identifier of the AF and an identifier of an authentication and key management for applications (AKMA) anchor key;
responsive to receiving the first request, send a second request to an AKMA anchor function (AAnF), the second request comprising the identifier for the AKMA anchor key;
responsive to sending the second request, receive a subscription permanent identifier (SUPI);
responsive to receiving the SUPI, retrieve user consent information; and
send the retrieved user consent information for use by the AF.

22-23. (canceled)
